(19) United States
(12) Patent Application Publication
(10) Pub. No.: US 2023/0198996 A1
(43) Pub. Date: Jun. 22, 2023

(54) METHODS, COMMUNICATION DEVICE AND SYSTEM FOR HANDLING ACCESS TO A SERVICE OF AN AUTHORIZATION-REQUIRING NETWORK

(71) Applicant: Telefonaktiebolaget LM Ericsson (publ), Stockholm (SE)

(72) Inventors: Tommy ARNGREN, Södra Sunderbyn (SE); Bernard SMEETS, Dalby (SE)

(73) Assignee: Telefonaktiebolaget LM Ericsson (publ), Stockholm (SE)

(21) Appl. No.: 17/926,351

(22) PCT Filed: May 19, 2020
(86) PCT No.: PCT/SE2020/050518

§ 371 Date: Nov. 18, 2022

(51) Int. Cl. H04L 9/40

(52) U.S. Cl. CPC H04L 63/105; H04L 63/0272; H04L 63/0876

(57) ABSTRACT

Disclosed is a method performed by a communication device (140) for handling access to a service of an authorization-requiring network (150), the communication device (140) being connected to a communication network (100).The method comprises initiating access to the service of the authorization-requiring network (150), and after the initiating of the access, obtaining information on a security level of a context of the communication device (140). The method further comprises sending, to a system (160) associated with the authorization-requiring network (150), the obtained information on the context security level, and when the obtained information of context security level corresponds to a context security level that is the same or higher than a required security level of the service of the authorization-requiring network (150), receiving, from the system (160) associated with the authorization-requiring network, an allowance to proceed with the access to the service of the authorization-requiring network (150).

### TECHNICAL FIELD

The present disclosure relates generally to methods, communication devices and network systems for handling access to a service of an authorization-requiring network, such as a Virtual Private Network, VPN. The present disclosure further relates to computer programs and carriers corresponding to the above methods, devices and systems.

### BACKGROUND

In the past, a bank customer would typically enter a bank office to perform his/hers transactions in a trusted environment. Today, a user can perform bank and money transactions anywhere and anytime using an electronic identification (eID). It is common today for users of communication devices such as smartphones, tablets, etc. to legitimize themselves using eID related to their money transactions, bank login, and other services provided by a bank or any other service provider providing their services via an authorization-requiring communication network, such as a VPN.

An eID is a digital solution for proof of identity of users, e.g. citizens or organizations, for example in view to access benefits or services provided by government authorities, banks or other companies, for mobile payments, etc. Apart from online authentication and login, many electronic identity services also give the users the option to sign electronic documents with a digital signature. One example of such an electronic identity service is BankID in Sweden that has 8 million active users. BankID is provided e.g. as an application for smartphones. Many services are provided where users can use their BankID for digital identification as well as signing transactions and documents. The services vary from online and mobile banking, e-trade to tax declaration and are provided by e.g. government, municipality, banks and companies. BankID is used both for identification as well as signing. According to Swedish law, and within the European Union, BankID is an advanced signature and a signature made with a BankID is legally binding.

The user’s identification is guaranteed by the bank issuing the BankID. Authorities, companies and other organizations must check the validity of the customer’s identity and signature. BankID is available on smart cards, computers, mobile phones and tablet devices.

However, the solutions of today does not guarantee a trusted environment for the use of eID initiated transactions, which makes it possible for fraudsters to intervene such transaction and get access to the users accounts etc. For example, the user may be pressed by nearby standing persons to access his/her bank account using his/her BankID and transfer money to any of the nearby standing persons.

### SUMMARY

It is an object of the invention to address at least some of the problems and issues outlined above. It is possible to achieve these objects and others by using methods, network nodes and wireless communication devices as defined in the attached independent claims.

According to one aspect, a method performed by a communication device for handling access to a service of an authorization-requiring network is provided. The communication device is connected to a communication network. The method comprises initiating access to the service of the authorization-requiring network, and after the initiating of the access, obtaining information on a security level of a context of the communication device. The method further comprises sending, to a system associated with the authorization-requiring network, the obtained information on the context security level, and when the obtained information of context security level corresponds to a context security level that is the same or higher than a required security level of the service of the authorization-requiring network, receiving, from the system associated with the authorization-requiring network, an allowance to proceed with the access to the service of the authorization-requiring network.

According to another aspect, a method performed by a system associated with an authorization-requiring network for handling access to a service of the authorization-requiring network is described. The method comprises receiving, from a communication device that has initiated access to the service of the authorization-requiring network, information on a context security level of the communication device, and determining whether the received information on context security level of the communication device corresponds to a context security level that is the same or higher than a required security level of the service the communication device has initiated access to. The method further comprises, when the context security level of the communication device is determined to be the same or higher than the required security level of the service, sending, to the communication device, an allowance to proceed with the access to the service of the authorization-requiring network.

According to another aspect, a communication device operable in a wireless communication system is provided, configured for handling access to a service of an authorization-requiring network. The communication device comprises a processing circuitry and a memory. Said memory contains instructions executable by said processing circuitry, whereby the communication device is operative for initiating access to the service of the authorization-requiring network, and after the initiating of the access, obtaining information on a security level of a context of the communication device. The communication device is further operative for sending, to a system associated with the authorization-requiring network, the obtained information on the context security level, and when the obtained information of context security level corresponds to a context security level that is the same or higher than a required security level of the service of the authorization-requiring network, receiving, from the system associated with the authorization-requiring network, an allowance to proceed with the access to the service of the authorization-requiring network.

According to yet another aspect, a system associated with an authorization-requiring network is provided, configured for handling access to a service of an authorization-requiring network. The system comprises a processing circuitry and a memory. Said memory contains instructions executable by said processing circuitry, whereby the system is operative for receiving, from a communication device that has initiated access to the service of the authorization-requiring network, information on a context security level of the communication device, and for determining whether the received information on context security level of the communication device corresponds to a context security level that is the same or higher than a required security level of the service the communication device has initiated access to. The system is further operative for sending, to the communication device, an allowance to proceed with the access to the service of the authorization-requiring network, when the context security level of the communication device is determined to be the same or higher than the required security level of the service.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a communication scenario and architecture in which the present invention may be used;

FIG. 2 is a flow chart illustrating a method performed by a communication device, according to possible embodiments;

FIG. 3 is a flow chart illustrating an embodiment that may be used together with the above method;

FIG. 4 is a flow chart illustrating a method performed by a system associated with an authorization-requiring network, according to possible embodiments;

FIG. 5 is a flow chart illustrating an embodiment that may be used together with the above method performed by the system.

FIG. 6 is another flow chart illustrating a method according to another embodiment.

FIG. 7 is a block diagram illustrating a communication device in more detail, according to further possible embodiments.

FIG. 8 is a block diagram illustrating a system associated with an authorization-requiring network in more detail, according to further possible embodiments.

### DETAILED DESCRIPTION

Briefly described, a solution is provided to raise security when using eID to access services of authorization-requiring communication networks. The solution includes level of trust related to a context of the user, i.e. the environment and surroundings in which the communication device is used when the user tries to access such a service using eID. The communication device obtains information on a security level of its context, and sends the information to a system of the authentication-requiring communication network that decides whether to allow the communication device access to the service based on the information on security level of the context of the communication device.

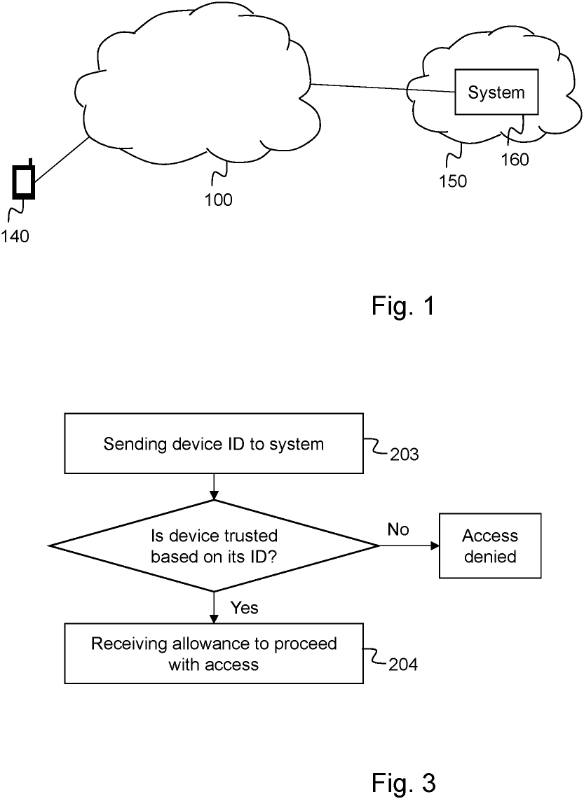

FIG. 1 shows a scenario in which a communication device 140 is connected to a communication network 100, through which the communication device 140 is connected to an authorization-requiring network 150, such as a VPN. The authorization-requiring network 150 has, or is connected to, a system 160 for performing authorization and/or authentication of a user of the communication device 140 in order to give the user access to services of the authorization-requiring network 150. The system 160 may be an authorization/authentication server or the system may be realized as a cloud-based solution with functionality spread out within the authorization-requiring network 150 or even outside the authorization-requiring network. The communication device is here realized as a wireless communication device and more specifically as a mobile phone. However, the communication device 140 may be any type of device capable of communicating wirelessly or via wireline with the communication network 100. For example, the communication device 140 may be a User Equipment (UE), a sensor, a tablet, a mobile terminal, a smart phone, a computer, a laptop etc.

The communication network 100 may be any kind of wireline or wireless communication network. Examples of wireless communication networks are Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE) i.e. 4^{th} Generation (4G) wireless communication network, LTE Advanced, Wireless Local Area Networks (WLAN), Worldwide Interoperability for Microwave Access (WiMAX), WiMAX Advanced, as well as 5^{th} generation (5G) wireless communication networks based on technology such as New Radio (NR).

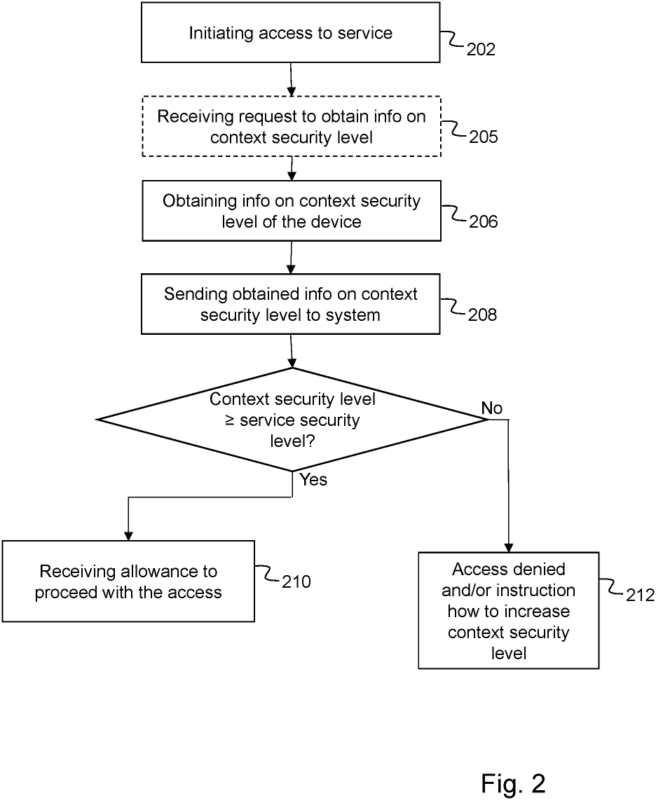

FIG. 2, in conjunction with FIG. 1, describes a method performed by a communication device 140 for handling access to a service of an authorization-requiring network 150, the communication device 140 being connected to a communication network 100. The method comprises initiating 202 access to the service of the authorization-requiring network 150, and after the initiating of the access, obtaining 206 information on a security level of a context of the communication device 140. The method further comprises sending 208, to a system 160 associated with the authorization-requiring network 150, the obtained information on the context security level, and when the obtained information of context security level corresponds to a context security level that is the same or higher than a required security level of the service of the authorization-requiring network 150, receiving 210, from the system 160 associated with the authorization-requiring network 150, an allowance to proceed with the access to the service of the authorization-requiring network 150.

The authorization-requiring network 150 may be any network that requires authentication and authorization for users of communication devices to enter the network or at least its service, e.g. a VPN. To initiate 202 access to a service may signify to start an application or entering a homepage of the authorization-requiring network where you request access to the service. The information on security level can be the actual security level or parameters that are used for determining the security level. The information on security level sent to the system 160 may even comprise a suggestion of whether to allow access. In this case, the device 140 may perform an analysis of whether it finds that the information of the context security level would be sufficient for the required context security level of the network and based on this analysis send a suggestion. At last, it would still be the system 160 of the authorization-requiring network 150 that makes the decision. The context of the communication device signifies the environment and surroundings in which the communication device is used when initiating the access. Examples are: what the environment around the device looks like, if it is safe or not, i.e. is the environment private or public, are there any other persons in the vicinity, how is the communication device connected to the communication network, i.e. via private Local Area Network (LAN), public LAN, or a public wide area wireless communication network such as 3G, 4G or 5G. That the system 160 is associated with the authorization-requiring network 150 signifies that the system may be arranged within the authorization-requiring network, e.g. as a server in the network, or that it is at least partly arranged outside the authorization-requiring network but communicatively connected to the authorization-requiring network. The system 160 may be realized as a cloud solution, i.e. the system may comprise functionality spread out over different nodes or networks.

By determining information on the context of the communication device, such as the surroundings of the device, a security level of the device can be determined. Such a security level is then compared to a required security level of the service that the user likes to access. If the context security level is acceptable for the service the user is allowed to carry on with accessing the service, if not, access may be denied. Hereby, it can be required that for performing a high-security-demanding service, such as transferring lots of money from one bank account to another bank account not belonging to the same user, the context of the communication device has to be considered to be secure. For example, it can be required that the communication device is on a location that is considered safe, such as at home. Hereby fraudulent use can be made more difficult, which in the end would give benefits to both service owners and users. The method can be realized as a mobile or web application to be run on a communication device.

According to an embodiment, after the initiating 202 of access, the method further comprises receiving 205 a request from the system 160 associated with the authentication network 150 to obtain 206 the information on security level of the context of the communication device. Such a request may be an active step performed by the system 160 or the communication device may be preconfigured to obtain the information on context security level in response to the initiating of access.

According to an embodiment, the information on the context security level is obtained 206 based on one or more of the following parameters: position of the communication device 140, time of day, whether there are any other communication device in the vicinity of the communication device 140, owner of such any other communication device, surroundings of the communication device taken from a sensor such as a camera, whether there are any other persons than a user registered with the communication device in the vicinity of the communication device 140, type of connection that the communication device has with the communication network 100.

The position of the communication device 140 may be taken from a positioning system such as Global Positioning System (GPS) or any communication network positioning system. Surroundings of the communication device determined by a sensor may be determined by e.g. the camera of the communication device or from any other camera or sensor in the vicinity of the communication device that can communicate with the communication device or directly with the system 160 of the authorization-requiring network 150. Whether there are any other person than the user in the vicinity may be determined from such a sensor or alternatively from information whether there are any other communication devices nearby, found by the communication device via its near field e.g. Bluetooth, communication abilities. The type of communication connection may be e.g. a wireless communication network such as 3G, 4G, 5G or WLAN network, and whether the WLAN network is an encrypted home network, work network or an open public network. The mentioned parameters individually or in combination would help in determining the context security level and therefore aid in determining the security in the user of the communication device using the service at this moment and location.

According to another embodiment, the method further comprises, when the obtained information on context security level corresponds to a context security level that is lower than a required security level of the service of the authorization-requiring network 150, receiving 212, from the system 160 associated with the authorization-requiring network, information that access to the service of the authorization-requiring network 150 is denied and/or an instruction of what to do to increase the context security level. The instruction may be an instruction to the user of the wireless device, displayed on the Graphical User Interface (GUI) of the device. Such an instruction may be to move to a safer place, possibly including where to find such a safe place. Hereby, any possible fraudulent use due which can occur due to the comparatively low context security level can be avoided. Also, the instruction of what to do to increase context security level can help the user to come to a safer place where the service can be used.

According to yet another embodiment, which is shown in FIG. 3, and to be used together with the embodiments described in FIG. 2, the method further comprising sending 203 a communication device ID to the system associated with the authorization-requiring network, and only when the system 160 of the authorization-requiring network 150 has determined that the communication device 140 is trusted based on its communication device ID, receiving 204 an allowance to proceed with the access and perform the obtaining 206 of the information of context security level. The sending of the communication device ID may comprise a request to the authorization-requiring network whether the communication device uses allowed hardware and/or software. The network may also check so that the communication device is owned by the person that has the account of the service to which the device requests access.

According to another embodiment, the required security level of the service comprises a plurality of different types of security levels that each has to be met. Further, the obtaining 206 comprises obtaining information on the plurality of different types of security levels of the context of the communication device 140, and the allowance to proceed with the access to the service is received 210 only when the plurality of different types of security levels are met.

According to yet another embodiment, the method further comprises performing a communication device part of an electronic ID authentication procedure, wherein the electronic ID authentication procedure is performed directly after the initiating 202 of access to the service or after the receiving 210 of the allowance to proceed with the access. Consequently, the method according to the other embodiments already described may be combined with such an eID authentication procedure.

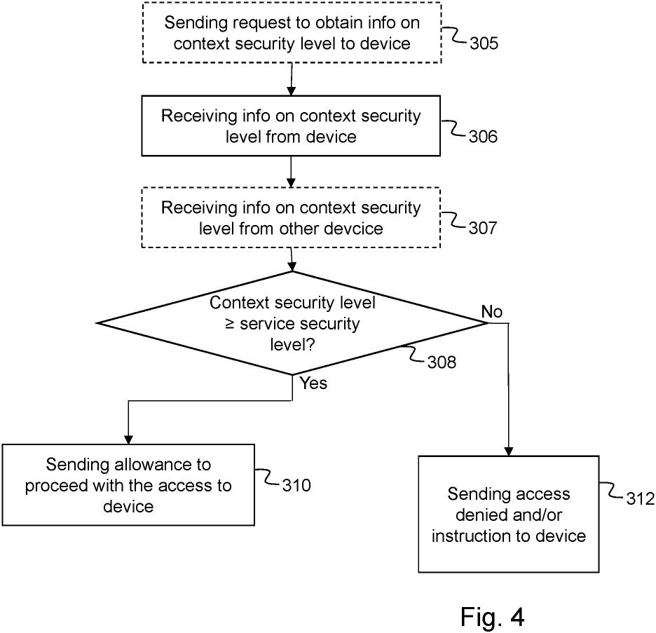

FIG. 4, in conjunction with FIG. 2, describes a method performed by a system 160 associated with an authorization-requiring network 150 for handling access to a service of the authorization-requiring network 150. The method comprises receiving 306, from a communication device 140 that has initiated access to the service of the authorization-requiring network 150, information on a context security level of the communication device 140, and determining 308 whether the received information on context security level of the communication device corresponds to a context security level that is the same or higher than a required security level of the service the communication device has initiated access to. The method further comprises, when the context security level of the communication device is determined to be the same or higher than the required security level of the service, sending 310, to the communication device 140, an allowance to proceed with the access to the service of the authorization-requiring network 150.

According to an embodiment, the method further comprises sending 305, to the communication device 140, a request to obtain the information on the context security level of the communication device.

According to another embodiment, the method further comprises, when the context security level of the communication device is determined 308 to be lower than the required security level of the service, sending 312, to the communication device 140, information that access to the service of the authorization-requiring network 150 is denied and/or an instruction of what to do to increase the context security level.

According to yet another embodiment, the method further comprises receiving 307, from a second communication device, information on the context security level of the communication device 140. Said another communication device may be a Closed Circuit Television (CCTV) camera arranged in the area where the communication device is located when initiating the access to the service. In this example the system determines whether the context security level is ok based on information from both the communication device and from the second communication device, e.g. in the vicinity of the communication device.

According to an alternative of this embodiment, the second communication device is a device in the vicinity of the communication device 140. Further, the method comprises sending a request to the second communication device to determine information on context security level of the communication device and to send the determined information to the system. Further, the information on the context security level of the communication device is received 307 from the second communication device in response to the sending of the request. That the second communication device is in the vicinity of the communication device 140 may be determined from matching of geographical positions of the communication device and the second communication device. The system may have received information on the geographical positions of the respective communication device from the communication device and the second communication device, respectively, or the system may have determined or obtained the position or positions from stored information. The latter is especially plausible for the second communication device when it is a stationary device, such as a CCTV camera. Such an embodiment is especially of interest when the system has difficulties to determine whether the received information on context security level of the communication device corresponds to a context security level that is the same or higher than the required service security level. Then it could be advantageous to verify the context security level from a nearby second communication device.

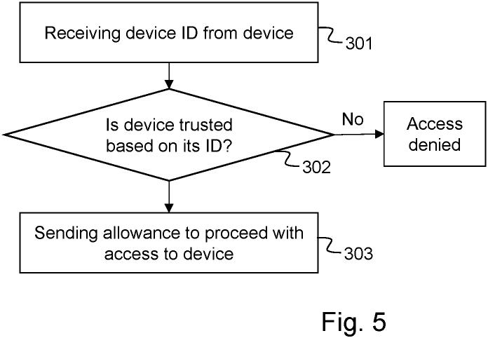

According to yet another embodiment, which is shown in FIG. 5, and to be used together with the embodiments described in FIG. 4, the method further comprises receiving 301 a device ID from the communication device 140, determining 302 whether the communication device 140 is trusted based on its device ID, and only when the communication device is determined to be trusted based on its device ID, sending 303, to the communication device 140, an allowance to proceed with the access.

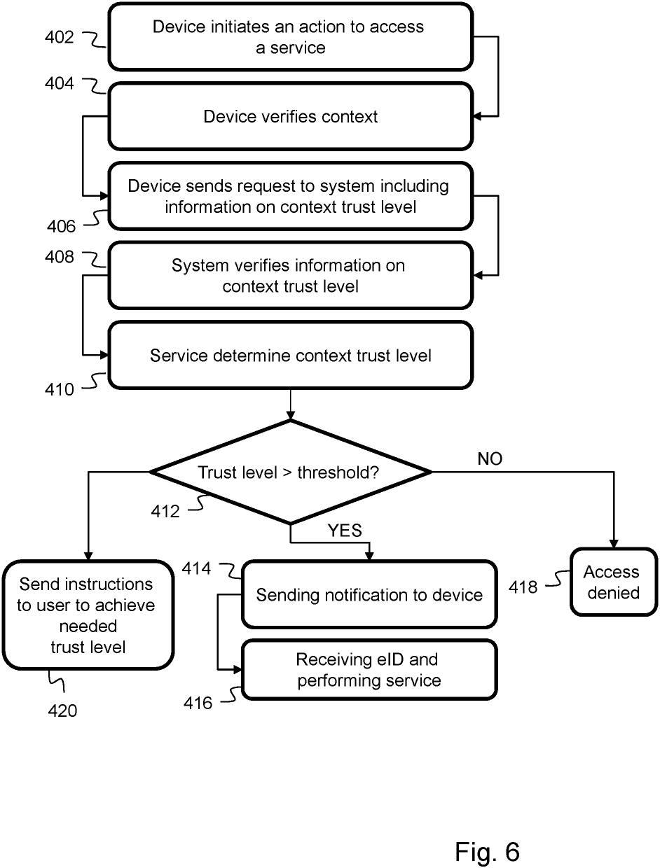

FIG. 6 describes an embodiment of a method for handling access to a service of an authorization-requiring network. The described method can be seen as comprising a security algorithm that includes levels of trust related to a context of the user and the user’s communication device and to a service context, a level of trust needed in order to perform a certain service such as a money transaction. The method starts by a communication device, such as device 140 of FIG. 1, initiating 402 an action access a service of an authentication-requiring network, such as network 150 of FIG. 1. After initiating access to the service, the communication device 140 verifies 404 its context, i.e. obtains information on a security level of its context. The information may comprise one or more of: location of the device, determined e.g. from GPS or from a Wi-Fi connection of the device; other communication devices detected in the vicinity of the communication device, determined via Bluetooth, Near Field Communication etc.; and surroundings of the communication device, determined from data of sensors of the device or other sensors in the vicinity. The sensors may be the camera of the device etc. The device then sends 406 a request to the access the service to a system associated with the authentication-requiring network, such as system 160 of FIG. 1. The request comprises the obtained information on device context security level, as well as device ID and/or user ID. The system may then check 408, i.e. verify, the obtained information on context security level with obtained network data related to this information. The context security level may also be called context trust level. The system then determines 410 the context trust level for the device based on the received information on device context security level. The context trust level may be determined as a value such as 1-10 or A-Z, where e.g. a higher number or later letter in the alphabet signifies a higher trust level. Thereafter, the determined trust level is compared 412 to a threshold needed for being allowed to access the service. The threshold may be different for different services. The threshold can be seen as a security level required by the service. When the determined trust level meets or is above the threshold, the system sends 414 a notification to the communication device, the notification comprising an allowance to proceed with the access to the service. The notification may trigger a prompt at the device to enter eID in order to perform the transaction. As a consequence, the device receives 416 the eID entered by the user, the eID is checked by the system in a regular matter and eventually the service, e.g. transaction, is performed. When, on the other side, the determined trust level is below the threshold, access to the service is denied 418 and the system sends a notification of the same to the communication device. On the other hand, when the determined trust level is below the threshold or when the information on context trust level is limited for some reason, the system may determine and send 420 a message to the communication device comprising instructions to the user what to do to achieve a needed trust level, such as moving to a location that is determined to be safe.

In FIG. 6, the trust level was depicted as a single value that is compared to a threshold. In practice the requirements that have to be fulfilled before a transaction can be carried out in a trustful manner are often multi-dimensional in the sense that different requirements cannot not be compared and/or it may make no sense to talk about the percentage or degree of fulfillment of how a requirement is met. Thus, requirements have in many cases to be considered independently. Hence the trust level for a transaction may be composed of a set of requirements and rules how these requirements need to be met. For example, it may be required that the user uses a trusted device for interaction with the service. If not, the transaction is not possible. Such a requirement is either met or it is not. Another requirement may be that the user is in a safe place of level 2, where “safe level 2” is determined by the service getting reliable information of sensors in the user’s service context that confirm that the user is at home or at his/her work office or alternatively there is a person close to the user that the user has registered as trustworthy. Safe level 1 could be defined as being in a service context that is not tagged as dangerous and where there is a trusted CCTV camera in the service context. Safe level 3 could be that the user is in a physically protected room where the user can call for assistance if threats are present outside the room. Information on context trust level that is obtained can either be explicitly trustworthy, e.g. provided by sensors that are verified to be secure, or the information can be trustworthy because the same information, for example the room’s safety condition, is provided by several sensors. Here a score could be used that defines the number of sensors that report the conditions that are mandatory to be met for the service to be performed. A required trust level for a service can thus be depicted as the minimal score in a spider web diagram where many dimensions have a 0 or 1 value and other dimensions may have multiple levels as described above.

Finally, in case the communication device is not a device in the sense of a single physical unit but is a materialization of a virtual device in a set of user interaction devices/equipment that are present where the user is, then a possible trust level can exist in the degree of trustworthiness of these devices used for creating the necessary interfaces for the user’s interaction with its virtual device, e.g. represented as a process or set of connected processes in a cloud based execution platform.

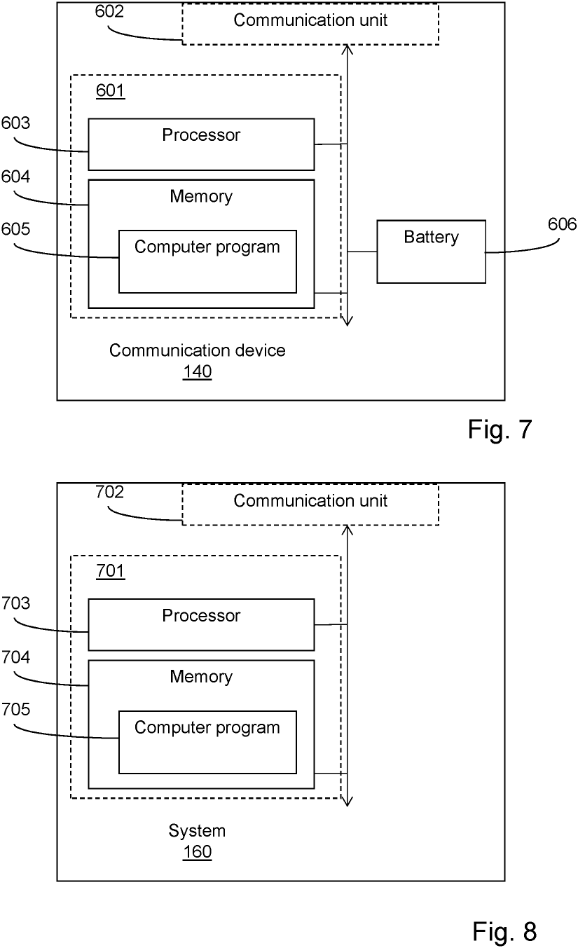

FIG. 7, in conjunction with FIG. 1, describes a communication device 140 operable in a wireless communication system 100 and configured for handling access to a service of an authorization-requiring network 150. The communication device 140 comprises a processing circuitry 603 and a memory 604. Said memory contains instructions executable by said processing circuitry, whereby the communication device 140 is operative for initiating access to the service of the authorization-requiring network 150, and after the initiating of the access, obtaining information on a security level of a context of the communication device 140. The communication device is further operative for sending, to a system 160 associated with the authorization-requiring network 150, the obtained information on the context security level, and when the obtained information of context security level corresponds to a context security level that is the same or higher than a required security level of the service of the authorization-requiring network 150, receiving, from the system 160 associated with the authorization-requiring network, an allowance to proceed with the access to the service of the authorization-requiring network 150.

According to an embodiment, the communication device 140 is further operative for, after the initiating of access, receiving a request from the system 160 associated with the authentication network 150 to obtain the information on security level of the context of the communication device.

According to another embodiment, the communication device 140 is operative for obtaining the information on the context security level based on one or more of: position of the communication device 140, time of day, whether there are any other communication device in the vicinity of the communication device 140, owner of such any other communication device, surroundings of the communication device taken from a sensor such as a camera, whether there are any other persons than a user registered with the communication device in the vicinity of the communication device 140, and type of connection that the communication device has with the communication network 100.

According to another embodiment, the communication device 140 is further operative for, when the obtained information on context security level corresponds to a context security level that is lower than a required security level of the service of the authorization-requiring network 150, receiving, from the system 160 associated with the authorization-requiring network, information that access to the service of the authorization-requiring network 150 is denied and/or an instruction of what to do to increase the context security level.

According to yet another embodiment, the communication device 140 is further operative for sending a communication device ID to the system 160 associated with the authorization-requiring network 150, and only when the system of the authorization-requiring network has determined that the communication device 140 is trusted based on its communication device ID, receiving an allowance to proceed with the access and perform the obtaining of the information of context security level.

According to yet another embodiment, the required security level of the service comprises a plurality of different types of security levels that have to be met. Further, the communication device is operative for the obtaining of the information on the plurality of different types of security levels of the context of the communication device 140, and the communication device is operable to receive the allowance to proceed with the access to the service only when the plurality of different types of security levels are met.

According to yet another embodiment, the communication device 140 is further operative for performing a communication device part of an electronic ID authentication procedure, and for performing the electronic ID authentication procedure directly after the initiating of access to the service or after the receiving of the allowance to proceed with the access.

According to other embodiments, the communication device 140 may further comprise a communication unit 602, which may be considered to comprise conventional means for communication with the communication network 100, such as a transceiver for wireless transmission and reception of signals from and to nodes in a wireless communication network. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions. The communication device may further comprise a battery 606.

The computer program 605 may be arranged such that when its instructions are run in the processing circuitry, they cause the communication device 140 to perform the steps described in any of the described embodiments of the communication device 140 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). Further, the computer program 605 may be carried by a separate computer-readable medium, such as a CD, DVD or flash memory, from which the program could be downloaded into the memory 604. Alternatively, the computer program may be stored on a server or any other entity to which the communication device 140 has access via the communication unit 602. The computer program 605 may then be downloaded from the server into the memory 604.

FIG. 8, in conjunction with FIG. 1, describes a system 160 associated with an authorization-requiring network 150, configured for handling access to a service of an authorization-requiring network 150. The system 160 comprises a processing circuitry 703 and a memory 704. Said memory contains instructions executable by said processing circuitry, whereby the system 160 is operative for receiving, from a communication device 140 that has initiated access to the service of the authorization-requiring network 150, information on a context security level of the communication device 140, and for determining whether the received information on context security level of the communication device corresponds to a context security level that is the same or higher than a required security level of the service the communication device has initiated access to. The system is further operative for sending, to the communication device 140, an allowance to proceed with the access to the service of the authorization-requiring network 150, when the context security level of the communication device is determined to be the same or higher than the required security level of the service.

That the system 160 is associated with the authorization-requiring network 150 signifies that the system may be arranged within the authorization-requiring network, e.g. as a server in the network, or that the system is at least partly arranged outside the authorization-requiring network but communicatively connected to the authorization-requiring network. The system 160 may be realized e.g. as a separate node or as a cloud solution, i.e. the system may comprise functionality spread out over different nodes or networks.

According to an embodiment, the system 160 is further operative for sending, to the communication device 140, a request to obtain the information on the context security level of the communication device.

According to another embodiment, the system 160 is further operative for:

when the context security level of the communication device is determined to be lower than the required security level of the service, sending, to the communication device 140, information that access to the service of the authorization-requiring network 150 is denied and/or an instruction of what to do to increase the context security level.

According to another embodiment, the system 160 is further operative for receiving, from a second communication device, information on the context security level of the communication device 140.

According to an alternative of this embodiment, the second communication device is a device in the vicinity of the communication device 140, and the system is further operative for sending a request to the second communication device to determine information on context security level of the communication device and to send the determined information to the system. Further, the system is operative for receiving the information on the context security level of the communication device from the second communication device in response to the sending of the request.

According to another embodiment, the system 160 is further operative for:
receiving a device ID from the communication device 140,
determining whether the communication device 140 is trusted based on its device ID, and
only when the communication device is determined to be trusted based on its device ID, sending, to the communication device 140, an allowance to proceed with the access.

According to other embodiments, the system 160 may further comprise a communication unit 702, which may be considered to comprise conventional means for communication with the communication device 140, via the communication network 100. The instructions executable by said processing circuitry 703 may be arranged as a computer program 705 stored e.g. in said memory 704. The processing circuitry 703 and the memory 704 may be arranged in a sub-arrangement 701. The sub-arrangement 701 may be a micro-processor and adequate software and storage therefore, a Programmable Logic Device, PLD, or other electronic component(s)/processing circuit(s) configured to perform the methods mentioned above. The processing circuitry 703 may comprise one or more programmable processor, application-specific integrated circuits, field programmable gate arrays or combinations of these adapted to execute instructions.

The computer program 705 may be arranged such that when its instructions are run in the processing circuitry, they cause the system 160 to perform the steps described in any of the described embodiments of the system 160 and its method. The computer program 705 may be carried by a computer program product connectable to the processing circuitry 703. The computer program product may be the memory 704, or at least arranged in the memory. The memory 704 may be realized as for example a RAM (Random-access memory), ROM (Read-Only Memory) or an EEPROM (Electrical Erasable Programmable ROM). Further, the computer program 705 may be carried by a separate computer-readable medium, such as a CD, DVD or flash memory, from which the program could be downloaded into the memory 704. Alternatively, the computer program may be stored on a server or any other entity to which the system 160 has access via the communication unit 702. The computer program 705 may then be downloaded from the server into the memory 704.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a communication device for handling access to a service of an authorization-requiring network, the communication device being connected to a communication network, the method comprising:
initiating access to the service of the authorization-requiring network;
after the initiating of the access, obtaining information on a security level of a context of the communication device;
sending, to a system associated with the authorization-requiring network, the obtained information on the context security; and
when the obtained information of context security level corresponds to a context security level that is the same or higher than a required security level of the service of the authorization-requiring network, receiving, from the system associated with the authorization-requiring network, an allowance to proceed with the access to the service of the authorization-requiring network.

2. The method of claim 1, further comprising, after the initiating of access, receiving a request from the system associated with the authentication network to obtain the information on security level of the context of the communication device.

3. The method of claim 1, wherein the information on the context security level is obtained based on one or more of: position of the communication device, time of day, whether there are any other communication devices in the vicinity of the communication device, owner of such any other communication device, surroundings of the communication device taken from a sensor such as a camera, whether there are any other persons than a user registered with the communication device in the vicinity of the communication device, and type of connection that the communication device has with the communication network.

4. The method of claim 1, further comprising:
when the obtained information on context security level corresponds to a context security level that is lower than a required security level of the service of the authorization-requiring network, receiving, from the system associated with the authorization-requiring network, information that access to the service of the authorization-requiring network is denied and/or an instruction of what to do to increase the context security level.

5. The method of claim 1, further comprising:
sending a communication device ID to the system associated with the authorization-requiring network, and
only when the system of the authorization-requiring network has determined that the communication device is trusted based on its communication device ID, receiving an allowance to proceed with the access and perform the obtaining of the information of context security level.

6. The method of claim 1, wherein the required security level of the service comprises a plurality of different types of security levels that have to be met, and wherein the obtaining comprises obtaining information on the plurality of different types of security levels of the context of the communication device, and the allowance to proceed with the access to the service is received only when the plurality of different types of security levels are met.

7. The method of claim 1, further comprising:
performing a communication device part of an electronic ID authentication procedure, wherein the electronic ID authentication procedure is performed directly after the initiating of access to the service or after the receiving of the allowance to proceed with the access.

8. A method performed by a system associated with an authorization-requiring network for handling access to a service of the authorization-requiring network, the method comprising:
receiving, from a communication device that has initiated access to the service of the authorization-requiring network, information on a context security level of the communication device;
determining whether the received information on context security level of the communication device corresponds to a context security level that is the same or higher than a required security level of the service the communication device has initiated access to; and
when the context security level of the communication device is determined to be the same or higher than the required security level of the service, sending, to the communication device, an allowance to proceed with the access to the service of the authorization-requiring network.

9. The method of claim 8, further comprising:
sending, to the communication device, a request to obtain the information on the context security level of the communication device.

10. The method of claim 8, further comprising:
when the context security level of the communication device is determined to be lower than the required security level of the service, sending, to the communication device, information that access to the service of the authorization-requiring network is denied and/or an instruction of what to do to increase the context security level.

11. The method of claim 8, further comprising:
receiving, from a second communication device, information on the context security level of the communication device.

12. The method of claim 11, wherein the second communication device is a device in the vicinity of the communication device, and the method further comprising:
sending a request to the second communication device to determine information on context security level of the communication device and to send the determined information to the system, and wherein the information on the context security level of the communication device is received from the second communication device in response to the sending of the request.

13. The method of claim 8, further comprising:
receiving a device ID from the communication device,
determining whether the communication device is trusted based on its device ID, and
only when the communication device is determined to be trusted based on its device ID, sending, to the communication device, an allowance to proceed with the access.

14. A communication device operable in a wireless communication system and configured for handling access to a service of an authorization-requiring network, the communication device comprising a processing circuitry and a memory, said memory containing instructions executable by said processing circuitry, whereby the communication device is operative for:
initiating access to the service of the authorization-requiring network;
after the initiating of the access, obtaining information on a security level of a context of the communication device;
sending, to a system associated with the authorization-requiring network, the obtained information on the context security level; and
when the obtained information of context security level corresponds to a context security level that is the same or higher than a required security level of the service of the authorization-requiring network, receiving, from the system associated with the authorization-requiring network, an allowance to proceed with the access to the service of the authorization-requiring network.

15. The communication device of claim 14, further being operative for, after the initiating of access, receiving a request from the system associated with the authentication network to obtain the information on security level of the context of the communication device.

16. The communication device of claim 14, operative for obtaining the information on the context security level based on one or more of: position of the communication device, time of day, whether there are any other communication devices in the vicinity of the communication device , owner of such any other communication device, surroundings of the communication device taken from a sensor such as a camera, whether there are any other persons than a user registered with the communication device in the vicinity of the communication device, and type of connection that the communication device has with the communication network.

17. The communication device of claim 14, further being operative for, when the obtained information on context security level corresponds to a context security level that is lower than a required security level of the service of the authorization-requiring network, receiving, from the system associated with the authorization-requiring network, information that access to the service of the authorization-requiring network is denied and/or an instruction of what to do to increase the context security level.

18. The communication device of claim 14, further being operative for sending a communication device ID to the system associated with the authorization-requiring network, and only when the system of the authorization-requiring network has determined that the communication device is trusted based on its communication device ID, receiving an allowance to proceed with the access and perform the obtaining of the information of context security level.

19. The communication device of claim 14, wherein the required security level of the service comprises a plurality of different types of security levels that have to be met, and wherein the communication device is operative for the obtaining of the information on the plurality of different types of security levels of the context of the communication device, and the communication device is operable to receive the allowance to proceed with the access to the service only when the plurality of different types of security levels are met.

20. (canceled)

21. A system associated with an authorization-requiring network, configured for handling access to a service of an authorization-requiring network,
the system comprising a processing circuitry and a memory, said memory containing instructions executable by said processing circuitry, whereby the system is operative for:
receiving, from a communication device that has initiated access to the service of the authorization-requiring network, information on a context security level of the communication device;
determining whether the received information on context security level of the communication device corresponds to a context security level that is the same or higher than a required security level of the service the communication device has initiated access to; and
when the context security level of the communication device is determined to be the same or higher than the required security level of the service, sending, to the communication device,
an allowance to proceed with the access to the service of the authorization-requiring network.

22-30. (canceled)
